(19) United States
(12) Patent Application Publication
(10) Pub. No.: US 2007/0149756 A1
(43) Pub. Date: Jun. 28, 2007

(54) Compositions and methods of manufacturing polytrimethylene naphthalate

(75) Inventor: Sanjay Tammaji Kulkarni, Chennai (IN)

Correspondence Address: SULLIVAN & WORCESTER LLP, ONE POST OFFICE SQUARE, BOSTON, MA, 02109, US

(73) Assignee: Futura Polyesters Limited

(21) Appl. No.: 11/603,266

(22) Filed: Nov. 21, 2006

(30) Foreign Application Priority Data
Dec. 26, 2005 (IN) 1620/MUM/2005

(51) Int. Cl. C08G 63/02

(52) U.S. Cl. 528/272

(57) ABSTRACT

The invention provides compositions and methods of manufacture of polytrimethylene naphthalate (PTN) made with reduced presence of acrolein by transesterifying naphthalene dicarboxylic acid dimethyl ester (NDC) with propylene glycol or 1,3 propane diol (PDO) in the presence of catalysts and one of more of nucleating agents, toners, thermal stabilizers, antioxidants, and end-capping agents.

### RELATED APPLICATIONS

This application claims the benefit of Indian Provisional Application Serial No. 1620/MUM/2005, filed on Dec. 26, 2005, which is hereby incorporated by reference in its entirety.

### FIELD OF THE INVENTION

This invention relates to compositions and methods of manufacturing polytrimethylene naphthalates (PTNs) (also known as polypropylene naphthalates (PPNs)). In particular, this invention relates to PTNs and processes for manufacturing PTNs, that are substantially free of acrolein, e.g., not in the detectable range.

### BACKGROUND OF THE INVENTION

Polyethylene terephthalate (PET) resins are widely used in the food packaging, bottle, and film industries. PET bottles have a large market share in the carbonated soft drink, fruit juice and bottled water sectors. These products have a shelf life of 8 to 12 weeks, over which period the gas permeability properties of PET are sufficient. However, alcoholic beverages such as beer and oxygen sensitive juices are more vulnerable to oxygen and carbon dioxide diffusion. To overcome the excessive gas ingress or egress characteristics of PET, bottle industry manufacturers use polyesters that have lower gas permeability. For example, storing beer in a PET bottle would require a barrier against CO₂ egress and O₂ ingress, while also retaining clarity and strength. The ideal barrier PET bottle for applications such as beer is a monolayer polyester structure in which a barrier resin or oxygen scavenger, or both, is blended with PET. New barrier materials such as nylon-based nanocomposites and “passive-active” barrier systems have also been used. The latter are dual-acting formulations of a passive barrier material and an active oxygen scavenger that blocks O₂ entry and also absorbs O₂ from the head space and bottle contents. However, in most cases these materials do not reduce the gas permeability sufficiently.

Polyethylene 2,6-naphthalate (PEN), a cousin of PET, typically delivers a five-fold improvement in both CO₂ and O₂ barrier versus monolayer PET, along with higher heat resistance and good clarity. PEN has a Tg of 122° C., far exceeding that for PET, thereby allowing PEN blend monolayer bottles to be pasteurized. Although PEN is far more effective as a passive barrier compared to PET, it is normally blended with PET because of PEN's high cost.

Another polyester that is closely related to PEN is polytrimethylene naphthalate (PTN), which has barrier properties for 02 and CO₂ that are far superior to PEN's, with transmission rates of O₂ and CO₂ that are about 25% less compared to PEN films. Low concentrations of PTN blended with PET provide a better and more cost effective passive barrier for specialized applications.

However, during the manufacture of PTN, acrolein or propenol is generated due to the presence of dipropylene glycol (DPG), which is formed by the dehydration of 1,3 propane diol (PDO). Acrolein is an unsaturated aldehyde that is highly reactive and highly toxic. Acrolein cross-links DNA and inhibits the activities of some enzymes (including cytochrome P450 and glutathionine-S-transferase) in vitro by reacting with sulfhydryl groups at active sites. Physiologically, acrolein suppresses pulmonary antibacterial defenses, produces irritation of the respiratory tract, increases airway resistance and tidal volume, decreases respiratory frequency, and may cause hypertension and tachycardia. Contact with acrolein may cause skin burns, erythema, and edema. Exposure to acrolein vapor concentrations as low as 10 ppm can lead to an asthmatic reaction, pulmonary edema, and death.

Acrolein is highly flammable and burns to produce irritating, corrosive and/or toxic gases. In the absence of an inhibitor, highly exothermic polymerization occurs at room temperature, catalysed by light and air or in the presence of traces of acids or strong bases. Acrolein vapor can travel to a source of ignition and flash back. Acrolein is therefore considered a dangerous contaminant that negatively affects the application of PTN while processing its melt at high temperatures, particularly in containers for sensitive beverages such as beer and fruit juices.

PTN and/or its copolyesters have been used to make fiber and films but no information has been reported on their acrolein content.

Patent No. GB 1115767 describes several block copolyesters consisting of a crystallizable polyester and a rubbery polyester. PTN is mentioned as one of the crystallizable polyesters.

Patent No. GB 1165312 describes helically crimpable composite staple fibers comprising two polymeric components. PTN is mentioned as a polyester component.

U.S. Pat. No. 6,525,165 B1 describes laminated aromatic polyester films containing PTN. Only laboratory scale preparation of PTN is exemplified and no details about the physical properties of the polymer are provided, with the exception of color, which is described as 65≦L−b and b≦10, where L and b are color values by Lab method, which indicates the polymer color is not in a satisfactory range. This could be due to the use of titanium tetrabutoxide as the catalyst. The PTN film is about 6 times less permeable to moisture and oxygen as compared to PET film.

U.S. Patent Application No. 20030143397 describes copolyester fiber that is resistant to both hydrolysis and fatigue from flexing and is capable of withstanding long term continuous usage at high temperature and humidity. One of the components used in the copolyester is PTN. No information is given about the process of making PTN.

Japanese Patent No. 2003320522 describes a method for producing a PTN composition by uniformly dispersing inert particles, which provides surface smoothness for film applications.

U.S. Pat. No. 6,740,402 describes a polyester fiber comprising a copolyester of PET and PEN along with 1,4-cyclohexanedimethanol (CHDM) as a glycol modifier. Little information is provided on the laboratory preparation of PTN and its copolyesters or details on the physical properties of the polymer.

A need therefore exists for a PTN that does not contain, or contains safe levels of, acrolein, and methods of manufacturing same.

### SUMMARY OF THE INVENTION

In one aspect, the invention provides polytrimethylene naphthalate (PTN) resins in which the formation of DPG is reduced, resulting in a decrease in the generation of acrolein in the resin, thereby providing a PTN polymer substantially free of acrolein. In an embodiment, the invention provides an SSP resin of PTN having acrolein content below the detectable limit, as measured by gas chromotography. In an embodiment, the invention provides an amorphous PTN polymer with an I.V. in the range of about 0.40 to about 0.50 dL/g. In another embodiment, the invention provides a polymer with improved color as measured by CIE ‘L’, ‘a’, and ‘b’ values.

In another aspect, the invention provides batch plant manufacturing processes for producing safe and effective passive PTN barrier resins that contain little or substantially no detectable acrolein. In an embodiment, the process comprises the use of at least two reactors. In another embodiment, the process comprises the use of three reactors.

In an embodiment, the invention provides methods of making a PTN polymer that is substantially free of acrolein, by (1) esterifying naphthalene dicarboxylic acid dimethyl ester (NDC) and 1,3-Propane diol (PDO), in the presence of at least one transesterification catalyst to form a prepolymer; and (2) polymerizing the prepolymer in the presence of one or more of a polymerization catalyst, a thermal stabilizer, a toner, and an end capping agent, thereby forming a polymer that is substantially free of acrolein. In an embodiment, one or more nucleating agents, antioxidants, and/or toners is added during the esterifying step. These components may be added simultaneously or sequentially, and in any order or combination.

In an embodiment, the esterifying step is carried out at about 200° C. to about 265° C. for about 4 to about 7 hours. In certain embodiments, the esterifying step comprises atmospheric distillation and vacuum distillation. For example, the atmospheric distillation is carried out at about 1050 mbar for about 200 minutes to about 360 minutes and the vacuum distillation is carried out at about 500 mbar for about 20 minutes to about 60 minutes.

In an embodiment, the transesterification catalyst is a compound comprising calcium, zinc, manganese, cobalt, antimony, titanium, tin, or a combination thereof. For example, the transesterification catalyst may be titanium acetate, calcium acetate, zinc acetate, manganese acetate, antimony trioxide, antimony triacetate, cobalt acetate, or a combination thereof. In certain embodiments, the transesterification catalyst is added at the start of the esterifying step. In another embodiment, the transesterification catalyst is added at the start of the esterifying step and may be added at a later stage during the esterifying step, e.g., in the middle of the esterifying step, for example, after collection of 50% of by-products.

In an embodiment, the nucleating agent is sodium benzoate, nano silica, nano clay, polybutylene naphthalate (PBN), ethylene acrylic acid sodium ionomer, micronized sorbitol, sodium salicylates, tungsten trioxide, or a combination thereof.

In an embodiment, the antioxidant is octadecyl 3,5-di-t-butyl-4-hydroxyhydrocinnamate, 3,5-di-t-butyl-4-hydroxyphenyl propionic acid methyl ester, benzenepropionic acid bis(dimethyl ethyl) hydroxy methyl ester, or a combination thereof.

In an embodiment, the toner is a red toner or a blue toner.

In an embodiment, the polymerizing step is carried out in the presence of one or more of a polymerization catalyst, thermal stabilizer, toner, and/or end capping agent at less than about 2 mbar at about 230° C. to about 270 ° C. for about 2 to about 7 hours. In an embodiment, the polymerizing step is carried out at less than about 2 mbar of pressure.

In an embodiment, the methods of the invention further comprise the step of transferring the prepolymer to a polyreactor after the transesterifying step.

In an embodiment, the polymerization catalyst is a compound comprising antimony, titanium, tin, or a combination thereof. For example, the polymerization catalyst may be tetrabutyl titanate (TnBT), butylstannoic acid, antimony trioxide, or a combination thereof.

In an embodiment, the thermal stabilizer may be orthophosphoric acid (OPA), triethylphophonoacetate (TEPA), or a combination thereof. In an embodiment, the thermal stabilizer is a mixture of OPA and TEPA, each used in the range of about 20 ppm to about 300 ppm as phosphorous, preferably in the range of about 30 ppm to about 150 ppm.

In an embodiment, the end capping agent is a monovalent aromatic hydroxy compounds or its haloformate, a monovalent carboxylic acid or its halide derivative, or a carbonic acid derivative, or a combination thereof. For example, the end capping agent may be tetrabutylphosphonium acetate (TBPA), ethylene carbonate, sodium methoxide, sodium phosphate, sodium citrate, or a combination thereof. It is believed that the end capping agent reduces the —COOH end group content in the PTN resin, which facilitates the reduction of the formation of acrolein.

In an embodiment, the methods further comprise a solid state polymerization (SSP) process comprising the step of precrystallizing the polymer at about 140° C. to form precrystallized chips. In another embodiment, the method further comprises the step of devolatilisation in which the temperature of the pre-crystallized chips is increased from about 35° C. to about 180° C. with nitrogen bleeding for about 5 to 8 hours and this is followed by crystallization in which the polyester chips are held at about 180° C. for about 1.5 to 3 hours at about 0.5 bar gauge pressure and then evacuated to vacuum below 1 mbar.

### DETAILED DESCRIPTION OF THE INVENTION

The invention provides compositions and manufacturing processes for polytrimethylene naphthalates (PTNs) with little or no acrolein content by reacting Dimethyl 2,6-naphthalenedicarboxylate (NDC) with 1,3-Propane diol (PDO) to produce transesterification compounds comprising bis(beta-hydroxypropyl)naphthalate or low molecular weight polymers thereof and polymerizing the resultant transesterification compounds to produce polypropylene naphthalate polymers. The method minimizes the formation of DPG, thereby minimizing the formation of acrolein. Not to be limited to any particular theory, DPG formation is believed to be controlled by a combination of resin composition, low processing temperature, and the addition of one or more of transesterification catalysts, nucleating agents, antioxidants, toners, polymerization catalysts, thermal stabilizers, and/or end capping agents. In addition, in an embodiment, the transesterifying step is carried out at about 215° C. compared to the usual 245° C. and the polymerizing step is conducted at about 230° C. compared to the usual 265° C. Other conventional processes use a maximum of about 280° C., which is not desirable for a resin of good quality and color. The invention therefore provides lower processing temperatures and superior thermal stability as evidenced by lower —COOH end groups, i.e., about 3 meq/kg instead of the normal high of about 15 meq/kg. The methods of the invention provide PTN polymers having less acrolein and propylene glycol by-products, with improved color.

The term “substantially free” in reference to acrolein content means that acrolein is not detectable by gas chromatography, e.g., using standard methods on a 6820 Agilent GC System (Agilent Technologies Inc., Santa Clara, Calif.) or that it is present in the PTN polymer in less than about 10 ppm, less than about 9 ppm, less than about 8 ppm, less than about 7 ppm, less than about 6 ppm, less than about 5 ppm, less than about 4 ppm, less than about 3 ppm, less than about 2 ppm, less than about 1 ppm, less than about 0.5 ppm, less than about 0.1 ppm, or less than about 0.05 ppm. In a particular embodiment, the acrolein content is less than about 0.1 ppm.

Transesterification catalysts useful in the invention include compounds that contain, for example, calcium, zinc, manganese, cobalt, antimony, titanium, or tin, and combinations thereof. Titanium acetate, calcium acetate, zinc acetate, manganese acetate, antimony trioxide, antimony triacetate, and/or cobalt acetate may be used in the concentration range of about 20 to about 300 ppm, preferably about 30 to about 250 ppm. Antimony trioxide as Sb may be used in the concentration range of about 100 to about 250 ppm. Cobalt acetate may be used in the range of about 20 to about 100 ppm, preferably about 30 to about 60 ppm. Tin catalyst acts as catalyst both for transesterification and polymerization and therefore may be added in two parts, both in the beginning of the transesterifying step and the end of the transesterifying step in the range of about 50 to about 500 ppm, preferably about 80 to about 400 ppm, at each stage.

In an embodiment of the invention, nucleating agents, antioxidants, and toners are used as additives during the transesterifying step to improve the rate of crystallization and color.

Nucleating agents useful in the invention include sodium benzoate, nano silica, nano clay, butyl propionic acid methyl ester, ethylene acrylic acid sodium ionomer, micronized sorbitol, sodium salicylates, tungsten trioxide, or a combination thereof. In an embodiment, sodium benzoate is added to about 20 to about 100 ppm, preferably about 30 to about 80 ppm. In another embodiment, nano silica (e.g., Nyacol®, Nanotechnologies, Inc., Austen, Tex.) is added to about 500 to about 3000 ppm, preferably to about 800 to about 2000 ppm. In another embodiment Nano clay (Nanolin DK2, Zhejiang Fenghong Clay Chemicals Co. Ltd, China) of CEC (Cationic Exchange Capability) 110-120 meq/100 g is added at about 100 to about 5000 ppm as a suspension in EG. In yet another embodiment, ethylene acrylic acid sodium ionomer (e.g., Aclyn®, Honeywell, USA) is added to about 50 to about 1000 ppm, preferably about 100 to about 500 ppm to improve the rate of crystallization. In an embodiment, sorbitol is used in the range of about 100 to about 5000 ppm, preferably in the range of about 1000 to about 2000 ppm; sodium salicylate is used in the range of about 10 to about 500 ppm, preferably in the range of about 30 to about 80 ppm; and/or tungsten trioxide is used in the range of about 5 to about 100 ppm, preferably in the range of about 20 to about 80 ppm.

Antioxidants useful in the invention include compounds such as hindered phenols, for example, octadecyl 3,5-di-t-butyl-4-hydroxyhydrocinnamate (e.g., Irganox 1076, Ciba Specialty Chemicals Corporation, USA), 3,5-di-t-butyl-4-hydroxyphenyl propionic acid methyl ester (e.g., Anox, Songwon, Ind. Co. Ltd., Korea), or benzenepropionic acid bis(dimethylethyl)hydroxymethyl ester (e.g., Ethanox®, Albemarle Corporation, USA), or a combination thereof. Octadecyl 3,5-di-t-butyl-4-hydroxyhydrocinnamate is used in the range of about 100 to about 150 ppm. Benzenepropionic acid bis(dimethylethyl)hydroxymethyl ester is used in the range of about 100 to about 500 ppm. 3,5-di-t-butyl-4-hydroxyphenyl propionic acid methyl ester is used in the range of about 100 to about 300 ppm.

Polysynthern Red GFP (8,9,10,11-Tetrachloro-12 H-phthaloperin-12 one—“Red Toner”) and Polysynthern Blue RBL (1,4-Bis(mesitylamino)anthraxquinone—“Blue Toner”) (Clariant Pigments & Additives, Switzerland), both as 0.15% EG solution, may be added along with other colorants like cobalt acetate during the transesterification reaction. The toners are added in the range of about 1 to about 4 ppm, preferably about 2 to about 3 ppm, to achieve the best color, e.g., with an International Commission on Illumination (CIE) color value of L greater than about 80 and b* value equal to about −1 to about −4.0.

In an embodiment of the transesterifying step, appropriate quantities of NDC and PDO and the required amount of transesterification catalyst and, optionally, a nucleating agent, a toner, and/or an antioxidant, are placed in the batch reactor. In an embodiment, transesterification is carried out in the esterifier at about 1050 mbar for about 4 to about 7 hours at about 200° C. to about 265° C. in the presence of at least one transesterification catalyst. The by-product methanol is removed by distillation. At the end of the transesterification, low molecular weight oligomers (prepolymers) or bis(betahydroxypropyl)naphthalate are formed. The prepolymer is transferred to a polyreactor for polymerization, e.g., via a 20 micron filter.

In an embodiment, as illustrated in Example 1, NDC and PDO in a molar ratio (NDC:PDO) of 1:1.43 are placed in an esterification reactor and two transesterification catalysts are added. The transesterification is carried out between about 200° C. and 245° C. for a period of about 5 to about 6 hours and methanol is removed as a byproduct.

In another embodiment, as illustrated in Example 2, NDC and PDO in a molar ratio (NDC:PDO) of 1:1.4 are placed in an esterification reactor and two transesterification catalysts are added. The transesterification is carried out between about 200° C and 240° C. for a period of about 260 minutes out of which atmospheric distillation is carried out at about 1050 mbar for about 230 minutes and vacuum distillation is carried out at about 500 mbar for about 30 minutes.

In another embodiment, as illustrated in Example 3, NDC and PDO in a molar ratio (NDC:PDO) of 1:1.5 are placed in an esterification reactor and three transesterification catalysts are added. The transesterification is carried out between about 200° C. and 230° C. for a period of about 370 minutes out of which atmospheric distillation is carried out at about 1050 mbar for about 340 minutes and vacuum distillation is carried out at about 500 mbar for about 30 minutes.

In another embodiment, as illustrated in Example 4, NDC and PDO in a molar ratio (NDC:PDO) of 1:1.4 are placed in an esterification reactor and two transesterification catalysts are added. In addition, another transesterification catalyst manganese acetate is added in two equal parts, one at the start of transesterification and the other at the end of transesterification. The transesterification is carried out between about 200° C. and 245° C. for a period of about 260 minutes out of which atmospheric distillation is carried out at about 1050 mbar for about 230 minutes and vacuum distillation is carried out at about 500 mbar for about 30 minutes.

In another embodiment, as illustrated in Example 5, NDC and PDO in a molar ratio (NDC:PDO) of 1:1.4 are placed in an esterification reactor and one transesterification catalyst is added. In addition, another transesterification catalyst manganese acetate is added in two equal parts, once at the start of transesterification and the other at the middle of transesterification. The transesterification is carried out between about 200° C. and 250° C. for a period of about 275 minutes out of which atmospheric distillation is carried out at about 1050 mbar for about 245 minutes and vacuum distillation is carried out at about 500 mbar for about 30 minutes.

In another embodiment, as illustrated in Example 6, NDC and PDO in a molar ratio (NDC:PDO) of 1:1.4 are placed in an esterification reactor and two transesterification catalysts are added. One or more nucleating agents are also added. The transesterification is carried out between about 200° C. and 245° C., preferably 220° C., for a period of about 6 hours and methanol removed as a byproduct. NDC and BDO are then added again such that the molar ratio (NDC:BDO) is 1:1.6 and the transesterification reaction is continued for another 2 hours maintaining the same temperature and pressure.

In an embodiment, the transesterification catalysts are added in combination, either together or sequentially. For example, manganese acetate is an ester interchange catalyst that may be added in the beginning of transesterification. Cobalt acetate may also be added in the beginning of transesterification. Manganese acetate may also be added after cobalt acetate. Tin acts as catalyst both for transesterification and polymerization and therefore may be added in two parts both in the beginning of transesterification and the end of transesterification.

In an embodiment of the invention, thermal stabilizers, toners, and/or end capping agents are used as additives during the polymerizing step while making PTN to reduce the formation of acrolein.

Thermal stabilizers useful in the invention include phosphorus-based compounds such as thermally stable organic bases such as orthophosphoric acid (OPA), triethylphosphonoacetate (TEPA), or a combination thereof. The thermal stabilizer TEPA is used in the range of about 30 to about 150 ppm and OPA in the range of about 10 to about 60 ppm.

End capping agents useful in the invention include monovalent aromatic hydroxy compounds and their haloformates, monovalent carboxylic acids and their halide derivatives, and carbonic acid derivatives such as ethylene carbonate and combinations thereof. In an embodiment, tetrabutyl phosphonium acetate (TBPA) is used as an end capping agent in the range of about 5 to about 200 ppm, preferably about 10 to about 80 ppm. In another embodiment, ethylene carbonate is used as an end capping agent in the range of about 1,000 to about 30,000 ppm, preferably in the range of about 12,000 to about 25,000 ppm, more preferably to about 15,000 ppm. In an embodiment, end capping agents are added during the polymerizing step after completion of the polymerizing step to reduce the number of —COOH end groups from greater than about 17 to less than about 3 meq/kg, which also suppresses the formation of acrolein.

In an embodiment, as illustrated in Example 1, the polymerizing step is carried out in a polyreactor after the transesterifying step. One or more polymerization catalysts and thermal stabilizers are added to the prepolymer and the polymerizing step is conducted at very low pressure (e.g., less than about 1 mm Hg absolute) at about 240° C. to about 270° C. with a process time of about 4 hours. After reaching the required molecular weight, as indicated by intrinsic viscosity (IV), one or more thermal stabilizers and end capping agents are added and allowed to interact thoroughly with the melt at about 230 ° C. with a pressure of about 1 mbar for about 30 minutes. The amorphous PTN polymer melt is extruded under nitrogen pressure and collected as pellets.

In another embodiment, as illustrated in Example 2, the polymerizing step is conducted at about 0.5 to about 2 bar gauge in the temperature range of about 240° C. to about 270° C. for about 130 minutes. After reaching the required molecular weight, one or more end capping agents are added and allowed to interact with the melt at about 230° C. with a pressure of about I mbar for about 30 minutes.

In another embodiment, as illustrated in Example 3, the polymerizing step is conducted in the presence of a single polymerization catalyst and a single thermal stabilizer at about 230 ° C. to about 260 ° C. for a period of about 300 minutes.

In another embodiment, as illustrated in Example 4, polymerization is conducted in the presence of a single polymerization catalyst and a single thermal stabilizer at about 245° C. to about 265° C. for a period of about 120 minutes.

In another embodiment, as illustrated in Example 6, polymerization is conducted in the presence of a single polymerization catalyst and more than one thermal stabilizer at very low pressure (less than about 1 mm Hg absolute) in the temperature range of about 230 ° C. to about 270 ° C., but preferably about 240° C., with a process time of about 4 hours. After reaching the required molecular weight, a thermal stabilizer and one or more end capping agents are added and allowed to interact thoroughly with the melt at about 230° C., with a pressure of about 1 mbar for about 30 minutes.

In an embodiment, the present invention provides a manufacturing process for producing amorphous PTN of I.V. in the range of about 0.4 to about 0.5 dL/g using a batch reactor system consisting of two or three reactors. In a two reactor system, in an embodiment of the invention, the transesterifying step is completed in the first reactor (esterifier) and transferred via a 20 micron filter to a second reactor followed by the polymerizing step in a second reactor (polyreactor or autoclave). In a three reactor system, in an embodiment of the invention, in between the transesterifier and polyreactor/autoclave steps there is an additional reactor (prepolyreactor) wherein part of the remaining transesterification (about 20%) under pressure and part of the initial polymerization (up to an I.V. of about 0.2 dL/g) under vacuum are conducted. The differences in the systems primarily result in increased production and better quality of the resin.

In the case of a three reactor system, in an embodiment, the low molecular weight melt is transferred after about 80% of the transesterifying step to a second prepolyreactor where the residual transesterification and the initial polymerization takes place. Post transesterification and prepolymerization is performed at about 500 to about 250 mbar for about 50 minutes. Subsequently, the prepolymer melt is transferred to the poly reactor via a 20 micron filter. The polymerizing step is carried out at about 250 to less than about 1 mbar for about 120 minutes, at about 240° C. to about 265° C., under low pressure. After the desired I.V. is reached, the amorphous polymer melt is extruded under nitrogen pressure and converted into pellets.

In another embodiment, the invention provides a solid state polymerization (SSP) process by which an amorphous polymer of I.V. of about 0.40 to about 0.50 dL/g is increased to about 0.60 to about 1.0 dL/g. SSP of low I.V. amorphous resins (e.g., I.V. of 0.35-0.45 dL/g) to high I.V. crystalline resins (e.g., I.V. of 0.45-0.90 dL/g and above) in the solid state is performed by heating the chips to a temperature of about 180° C. to about 200° C. for about 12 to about 24 hours, depending on the final I.V. required, in a tumbling batch reactor or in a continuous reactor. In the case of a batch reactor, the reaction is carried out under vacuum at a pressure of less than about 1 mbar. In the case of a continuous reactor, the reaction is carried out in the presence of a counter current of inert gas such as nitrogen at ambient pressure.

The present invention thus provides a process in a batch reactor system, comprising two or three reactors, for PTN polymers with reduced acrolein content by esterifying NDC, or derivatives thereof, with PDO, followed by polymerization and, optionally, SSP.

Practice of the invention will be still more fully understood from the following examples, which are presented herein for illustration only and should not be construed as limiting the invention in any way.

### EXEMPLIFICATION

### Example 1

### Production of PTN Polymer Substantially Free of Acrolein

About 9.5 kg of Dimethyl 2,6-naphthalenedicarboxylate (NDC) and 4.2 kg of 1,3-Propane Diol (PDO) are placed in an esterification reactor at a molar ratio (NDC:PDO) of about 1:1.43. Manganese acetate (40 ppm as Mn) and cobalt acetate (40 ppm as Co) are added as transesterification catalysts. The esterifying step is carried out between about 200° C. and 245° C. for a period of about 5 to about 6 hours. Methanol is removed as a byproduct. The prepolymer formed is transferred via a 20 micron filter to a polyreactor. Polymerization catalyst butylstannoic acid is added at about 200 ppm and subsequently phosphorous based thermal stabilizers such as orthophosphoric acid (OPA) and triethylphophonoacetate (TEPA) are added such that the total phosphorus content is 40 ppm, e.g., 20 ppm each. The polymerizing step is conducted at very low pressure (e.g., less than about 1 mm Hg absolute) at about 240° C. to about 270° C. with a process time of about 4 hours. After reaching the required molecular weight, as indicated by intrinsic viscosity (IV), the end capping additives tetrabutyl phosphonium acetate and ethylene carbonate are added to about 50 ppm and 0.5% w/w are added, respectively, and allowed to interact thoroughly with the melt at about 230° C. with a pressure of about 1 mbar for 30 minutes. The amorphous PTN polymer melt is extruded under nitrogen pressure and collected as pellets.

Table-I summarizes some characteristics of the amorphous PTN polymer.

TABLE I

| Ser. No. | PARAMETER | UNIT | VALUE |
|---|---|---|---|
| 1 | Intrinsic Viscosity | dL/g | 0.38 |
| 2 | Carboxyl Number | meq/kg | 2 |
| 3 | Dipropylene Glycol | Wt. % | 0.08 |
| 4 | Acrolein | Ppm | 3.5 |
| 5 | L* amorphous/crystalline | CIE | 55/81 |
| 6 | a* | CIE | −1.0/−1.7 |
| 7 | b* | CIE | −1.8/−1.1 |
| 8 | T_{g} | ° C. | 80.7 |
| 9 | Tₘ | ° C. | 205 |
| 10 | T_{ch} | ° C. | 167 |

Note:
T_{g} = Glass transition temperature;
Tₘ = Melting point;
T_{ch} = Crystallization temperature during heating in the second heating cycle.
The above three parameters are obtained by differential scanning calorimetry (DSC) with a heat cycle 1 and 2 of about 30° C. to about 300° C. at about 10° C./minute and rapid cooling cycle from about 300° C. to about 30° C. thermal analysis measurements.

The amorphous PTN is upgraded to higher I.V. by solid state polymerization (SSP). The amorphous PTN resin is precrystallised at about 140° C. in a fluid bed precrystallizer. The cooled precrystallized PTN chips are transferred to a tumbling dryer and the chip temperature is increased from about 35° C. to 180° C. with nitrogen bleeding for about 6 hours. This is followed by crystallization in which the polyester chips are held at about 180° C. for about 2 hours at about 0.5 bar gauge pressure and then evacuated to vacuum below about 1 mbar.

Table II summarizes some characteristics of the SSP product.

TABLE II

| | I.V. | | L* | a* | b* | Tg | Tm |
|---|---|---|---|---|---|---|---|
| PTN | dL/g | Acrolein, ppm | CIE | CIE | CIE | ° C. | ° C. |
| Amorphous Feed Resin | 0.432 | 3.4 | 57 | −0.8 | −1.6 | 80.7 | 205.9 |
| Final SSP resin | 0.590 | <0.1 (below | 73 | −1.5 | −1.0 | 79.3 | 202.5 |
| | | detectable limit) | | | | | |

Note:
T_{g} = Glass transition temperature;
Tₘ = Melting point.

### Example 2

### Production of PTN Polymer Substantially Free of Acrolein

NDC and PDO are mixed in a 1:1.4 molar ratio. Manganese acetate (40 ppm as Mn) and cobalt acetate (50 ppm as Co) are added as transesterification catalysts. The transesterifying step is carried out between about 200° C. and 240° C. for a period of about 260 minutes, out of which atmospheric distillation is carried out at about 1050 mbar for about 230 minutes and vacuum distillation is carried out at about 500 mbar for about 30 minutes. The prepolymer formed is transferred to a polyreactor. About 200 ppm of the polymerization catalyst antimony, about 7 ppm of the polymerization catalyst tetrabutyl titanate (TnBT) (as titanium) and about 60 ppm of thermal stabilizer triethyl phosphonoacetate (TEPA) (as phosphorus) are added. The polymerizing step is conducted at about 0.5 to about 2 bar gauge in the temperature range of about 240° C. to about 270° C. for about 130 minutes. After reaching the required molecular weight, about 17 ppm of end capping agent tetrabutylphosphonium acetate (TBPA) and about 4200 ppm end capping agent ethylene carbonate are added and allowed to interact with the melt at about 230° C. with a pressure of about 1 mbar for about 30 minutes. The amorphous polymer melt is extruded under nitrogen pressure and collected as pellets.

### Example 3

### Production of PTN Polymer Substantially Free of Acrolein

NDC and PDO are mixed at a molar ratio of about 1:1.5 in an esterification reactor. Cobalt acetate (20 ppm as Co), manganese acetate (40 ppm as Mn) and antimony trioxide (220 ppm as Sb) are added as transesterification catalysts. The transesterifying step is carried out between about 200° C. to about 230 ° C. for a period of about 370 minutes. Atmospheric distillation is carried out at about 1050 mbar for about 340 minutes and vacuum distillation is carried out at about 500 mbar for about 30 minutes, thus accounting for 370 minutes. The prepolymer formed is transferred to a polyreactor. Thermal stabilizer TEPA is added such that the phosphorus content is 60 ppm along with 5 ppm of polymerization catalyst TnBT. The polymerizing step is conducted at about 230° C. to about 260° C. for a period of about 300 minutes. The amorphous polymer melt is extruded under nitrogen pressure at about 0.5 to about 2 bar gauge and collected as pellets.

### Example 4

### Production of PTN Polymer Substantially Free of Acrolein

NDC and PDO are mixed at a molar ratio of about 1:1.4 in an esterification reactor. Antimony trioxide (120 ppm as Sb) and cobalt acetate (60 ppm as Co) are added as esterification catalysts. In addition, 50 ppm of transesterification catalyst manganese acetate is added in two equal parts, at about 25 ppm each time, once at the start of the transesterifying step and the other at the middle of the transesterifying step. The transesterifying step is carried out between about 200° C. to about 245° C. for a period of about 260 minutes. Out of 260 minutes, atmospheric distillation is carried out at about 1050 mbar for about 230 minutes and vacuum distillation is carried out at about 500 mbar for about 30 minutes. The prepolymer formed is transferred to a polyreactor. About 80 ppm of thermal stabilizer TEPA and about 15 ppm of polymerization catalyst TnBT are then added and the polymerizing step is conducted at about 245° C. to about 265° C. for a period of about 120 minutes. The amorphous polymer melt is then extruded under nitrogen pressure and collected as pellets.

### Example 5

### Production of PTN Polymer Substantially Free of Acrolein

NDC and PDO are mixed at a molar ratio of 1:1.4 in an esterification reactor. Cobalt acetate (50 pp m as Co) is added as an transesterification catalyst and manganese acetate (60 ppm as Mn) is added as an transesterification catalyst in two equal parts, one at the start of the esterifying step and other part at the middle of the transesterifying step, about 30 ppm each time. The transesterifying step is carried out between about 200° C. to about 250° C. for about 275 minutes. The atmospheric distillation is carried out at about 1050 mbar for about 245 minutes and vacuum distillation at about 500 mbar for about 30 minutes, thus accounting for about 275 minutes. The prepolymer formed is transferred to a polyreactor. Thermal stabilizer TEPA is added such that the phosphorus content is about 60 ppm and polymerization titanium catalyst is added to about 15 ppm. The polymerization is conducted at about 250° C. to about 270 ° C. for a period of about 120 minutes. The amorphous polymer melt is extruded under nitrogen pressure and collected as pellets.

### Example 6

### Production of PTN Polymer Substantially Free of Acrolein

About 9.05 kg of NDC and about 3.946 kg of PDO are placed in an esterification reactor such that the molar ratio of NDC:PDO is 1:1.4. Manganese acetate (40 ppm as Mn) and cobalt acetate (40 ppm as Co) are added as transesterification catalysts. About 10 ppm of tungsten trioxide, not more than about 1000 ppm of a nanocompound such as nano clay or nanosilica (Nyacol) and about 30 ppm of sodium benzoate are also added as nucleating agents. Transesterification is carried out between about 200° C. and 245° C., but preferably at about 220° C., for a period of about 6 hours. Methanol is removed as a byproduct. To this, 0.454 kg of NDC and 0.268 kg of 1,4-butanediol (BDO), for in situ formation of polybutylene naphthalate (PBN), are added to the esterification reactor such that the molar ratio is about 1:1.6. The transesterification reaction is continued for another 2 hours maintaining the same temperature and pressure. The prepolymer formed is transferred to a polyreactor through a 20 micron filter. A polymerization catalyst such as butylstannoic acid is added such that its ppm is about 200 and subsequently phosphorous based thermal stabilizers such as OPA (as P) at about 50 pp m and about 100 ppm of TEPA (as P) are added. By using organic tin based compounds instead of the conventional Sb or Ti, etc., superior color is obtained in the resin. The polymerizing step is conducted at very low pressure (e.g., less than about I mbar) in the temperature range of about 230 ° C. to about 270 ° C., but preferably about 240° C., with a process time of about 4 hours. After reaching the required molecular weight, end capping agents TBPA (about 50 pp m) and ethylene carbonate (about 1.5%), sodium methoxide, sodium phosphate, or sodium citrate (about 0.005%) for tetrahydrofuran (THF) suppression, THF being a byproduct that forms during the in situ polymerization of NDC & BDO to PBN, are added and allowed to interact thoroughly with the melt at about 230 ° C. with a pressure of about 1 mbar for about 30 minutes. The amorphous polymer melt is extruded under nitrogen pressure and collected as pellets.

### Example 7

### Production of PTN Polymer Substantially Free of Acrolein

The molar ratio of NDC and PDO is 1:1.2. 9.5 Kg of NDC and 3.5 Kg of PDO are mixed in an esterification reactor. To the above mixture, Manganese acetate (50 pp m as Mn) is added in two equal parts, one at the initial stage and the other in the middle of the transesterfication, e.g., after collection of 50% of methanol, and butylstannoic acid (200 ppm as Sn) which is also added in two equal parts, one at the initial stage and the other at end of the transesterfication. Cobalt acetate (35 ppm as Co) and Tungsten trioxide (7 ppm as W) are also added to the esterification reactor. The transesterifcation reaction is carried at about 200° C. to about 235° C. for about 300 minutes. Atmospheric distillation is carried out at about 1050 mbar for about 240 minutes and vacuum distillation is carried out at about 500 mbar for about 60 minutes. The prepolymer formed is transferred to the poly reactor. 150 pp m of TEPA (as P) and 5 ppm of TnBT (as Ti) are added to the poly reactor. The polymerization cycle is carried out by increasing the temperature from 235° C. to 250° C. and decreasing the pressure from 500 mbar to about 5 mbar for 150 minutes. After reaching the required molecular weight, end capping agent ethylene carbonate (15000 ppm) and TBPA (20 ppm) are added to the melt and allowed to react thoroughly with the melt. The temperature is maintained at 245° C. and pressure at 5 mbar for about 30 minutes. The amorphous polymer melt is then extruded under nitrogen pressure and collected as pellets.

Table III summarizes some characteristics of the amorphous PTN polymer.

TABLE III

| | | Carboxyl | | | | | | | | |
|---|---|---|---|---|---|---|---|---|---|---|
| Example | IV | number | Dipropylene | Acrolein | L* | a* | b* | Tg | Tm | Tch |
| No | (dL/g) | (meq/kg) | glycol wt % | (ppm)⁺ | CIE | CIE | CIE | ° C. | ° C. | ° C. |
| 2. | 0.426 | 2 | 0.07 | 0.61 | 80.9 | −2.0 | −1.5 | 78.1 | 204.5 | 160.6 |
| 3. | 0.455 | 6 | 0.094 | 0.88 | 64.3 | −1 | −2.1 | 78.8 | 204.6 | 166.3 |
| 4. | 0.475 | 17 | 0.13 | 3.5 | 80.8 | −1.5 | −3.3 | 78.4 | 204.1 | 165.2 |
| 5. | 0.456 | 16 | 0.16 | 2.24 | 80.6 | −1.6 | −3.6 | 79.1 | 203.9 | 164.8 |
| 6. | 0.380 | 2 | 0.08 | 0.74 | 81.0 | −1.0 | −1.8 | 80.7 | 205.0 | 167.0 |
| 7. | 0.366 | 2 | 0.04 | 0.58 | 82.2 | −1.5 | −0.2 | 77.3 | 203.4 | 138.7 |

⁺As indicated earlier in Table, II these values for Acrolein are <0.1 ppm (below detectable limit) when the amorphous PTN is subjected to SSP to get the required high I.V.
Note:
T_{g} = Glass transition temperature;
Tₘ = Melting point;
T_{ch} = Crystallization temperature during heating in the second heating cycle.

### INCORPORATION BY REFERENCE

The contents of all cited references (including literature references, patents, patent applications, and websites) that may be cited throughout this application are hereby expressly incorporated by reference. The practice of the present invention will employ, unless otherwise indicated, conventional techniques of polymer manufacture, which are well known in the art.

### EQUIVALENTS

The invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims rather than by the foregoing description, and all changes that come within the meaning and range of equivalency of the claims are therefore intended to be embraced herein.

We claim:

1. A polytrimethylene naphthalate (PTN) polymer substantially free of acrolein:

2. The PTN polymer according to claim 1, wherein the acrolein content is not detectable by gas chromatography.

3. The PTN polymer according to claim 1, wherein the acrolein content is less than about 10 ppm, less than about 9 ppm, less than about 8 ppm, less than about 7 ppm, less than about 6 ppm, less than about 5 ppm, less than about 4 ppm, less than about 3 ppm, less than about 2 ppm, less than about 1 ppm, less than about 0.5 ppm, less than about 0.2 ppm, less than about 0.1 ppm.

4. The PTN polymer according to claim 1, wherein the acrolein content is less than about 0.1 ppm.

5. A method of making a polytrimethylene naphthalate (PTN) polymer that is substantially free of acrolein, the method comprising the steps of:
transesterifying naphthalene dicarboxylic acid dimethyl ester (NDC) and 1,3-Propane diol (PDO) in the presence of at least one transesterification catalyst to form a prepolymer; and
polymerizing the prepolymer in the presence of at least one of a polymerization catalyst, a thermal stabilizer, and an endcapping agent, thereby forming a polymer that is substantially free of acrolein.

6. The method according to claim 5, wherein the transesterifying step is carried out at about 200° C. to about 265° C.

7. The method according to claim 5, wherein the transesterifying step is carried out at about 200° C. to about 250° C.

8. The method according to claim 5, wherein the transesterifying step is carried out for about 4 hours to about 7 hours.

9. The method according to claim 5, wherein the transesterifying step is carried out for about 4 hours to about 6.2 hours.

10. The method according to claim 5, wherein the transesterifying step comprises atmospheric distillation and/or vacuum distillation.

11. The method according to claim 10, wherein the atmospheric distillation is carried out at about 1050 mbar for about 200 minutes to about 360 minutes.

12. The method according to claim 10, wherein the atmospheric distillation is carried out at about 1050 mbar for about 200 minutes to about 340 minutes.

13. The method according to claim 10, wherein the vacuum distillation is carried out at about 500 mbar for about 20 minutes to about 60 minutes.

14. The method according to claim 10, wherein the vacuum distillation is carried out at about 500 mbar for about 20 minutes to about 30 minutes.

15. The method according to claim 5, wherein the transesterification catalyst is a compound comprising an element selected from the group consisting of calcium, zinc, manganese, cobalt, antimony, titanium, tin, and a combination thereof.

16. The method according to claim 5, wherein the transesterification catalyst is selected from the group consisting of titanium acetate, calcium acetate, zinc acetate, manganese acetate, antimony trioxide, antimony triacetate, cobalt acetate, and a combination thereof.

17. The method according to claim 5, wherein manganese acetate and cobalt acetate are added as transesterification catalysts.

18. The method according to claim 5, wherein manganese acetate, cobalt acetate, and antimony trioxide are added as transesterification catalysts.

19. The method according to claim 5, wherein the transesterification catalyst is added at the start of the transesterifying step.

20. The method according to claim 5, wherein manganese acetate is added at the start of the transesterifying step.

21. The method according to claim 5, further comprising the step of transferring the prepolymer to a polyreactor after the transesterifying step.

22. The method according to claim 5, wherein the polymerizing step is carried out at less than about 1 mbar at about 220° C. to about 300° C.

23. The method according to claim 5, wherein the polymerizing step is carried out at less than about 1 mbar at about 230° C. to about 270° C.

24. The method according to claim 5, wherein the polymerizing step is carried out for about 2 to about 7 hours.

25. The method according to claim 5, wherein the polymerizing step is carried out for about 2 to about 5 hours.

26. The method according to claim 5, wherein the polymerization catalyst is a compound comprising an element selected from the group consisting of antimony, titanium, tin, and a combination thereof.

27. The method according to claim 5, wherein the polymerization catalyst is selected from the group consisting of tetrabutyl titanate (TnBT), antimony trioxide, butylstannoic acid, and a combination thereof.

28. The method according to claim 5, wherein tetrabutyl titanate (TnBT) is added as a polymerization catalyst.

29. The method according to claim 5, wherein antimony and tetrabutyl titanate (TnBT) are added as polymerization catalysts.

30. The method according to claim 5, wherein the thermal stabilizer is selected from the group consisting of orthophosphoric acid (OPA), Triethylphophonoacetate (TEPA), and a combination thereof.

31. The method according to claim 5, wherein the end capping agent is selected from the group consisting of monovalent aromatic hydroxy compounds and their haloformates, monovalent carboxylic acids and their halide derivatives, carbonic acid derivatives, and a combination thereof.

32. The method according to claim 5, wherein the end capping agent is selected from the group consisting of tetrabutylphosphonium acetate (TBPA), ethylene carbonate, sodium methoxide, sodium phosphate, sodium citrate, and a combination thereof.

33. The method according to claim 5, wherein tetrabutylphosphonium acetate (TBPA) and ethylene carbonate are added as end capping agents.

34. The method according to claim 5, further comprising the step of precrystallizing the polymer at about 80° C. to about 150° C. to form precrystallized chips.

35. The method according to claim 34, further comprising the step of crystallizing the precrystallized chips by heating from about 35° C. to 180° C. with nitrogen bleeding for about 6 hours and this is followed by crystallization in which the polyester chips are held at about 180° C. for about 2 hours at about 0.5 bar gauge pressure and evacuated to vacuum below 1 mbar.

36. The method according to claim 5, wherein a nucleating agent is added during the transesterifying step.

37. The method according to claim 36, wherein the nucleating agent is selected from the group consisting of sodium benzoate, nano silica, nano clay, polybutylene naphthalate (PBN) ethylene acrylic acid sodium ionomer, micronized sorbitol, sodium salicylates, tungsten trioxide, and a combination thereof.

38. The method according to claim 5, wherein an antioxidant is added during the transesterifying step.

39. The method according to claim 38, wherein the antioxidant is selected from the group consisting of octadecyl 3,5-di-t-butyl-4-hydroxyhydrocinnamate, 3,5-di-t-butyl-4-hydroxyphenyl propionic acid methyl ester, benzenepropionic acid bis(dimethylethyl)hydroxymethyl ester, and a combination thereof.

40. The method according to claim 5, wherein a toner is added during the transesterifying step and/or the polymerizing step.

41. The method according to claim 40, wherein the toner is selected from the group consisting of red toner and blue toner, and a combination thereof.
